(19) United States
(12) Patent Application Publication
(10) Pub. No.: US 2016/0015201 A1
(43) Pub. Date: Jan. 21, 2016

(54) DECORATIVE TREE BRANCH EXTENSIONS

(71) Applicant: Gladys Morales, Chicago, IL (US)

(72) Inventor: Gladys Morales, Chicago, IL (US)

(21) Appl. No.: 14/679,606

(22) Filed: Apr. 6, 2015

Related U.S. Application Data
(60) Provisional application No. 62/026,208, filed on Jul. 18, 2014.

(51) Int. Cl. A47G 33/08; B44F 7/00; B44F 9/00

(52) U.S. Cl. CPC A47G 33/08; B44F 9/00; B44F 7/00

(57) ABSTRACT

A decorative branch extension comprising an elongate stem which supports decorations along the length of the stem and further comprising a flexible circular ring at the end of the stem having an open section of arc to receive the center pole or trunk of a tree.

### CLAIM OF PRIORITY

This patent application claims priority under 35 USC 119 (e) (1) from U.S. Provisional Patent Application Ser. No. 62/026,208 filed Jul. 18, 2014, of common inventorship herewith entitled, “Christmas Tree Branch Extensions,” which is incorporated herein by reference as though the same were set forth in its entirety.

### FIELD OF THE INVENTION

The present invention pertains to the field of decorations for trees including Christmas decorations, and more specifically to the field of decorations for artificial and real trees.

### BACKGROUND OF THE INVENTION

The prior art has put forth several designs for artificial Christmas trees. Among these are:

U.S. Pat. No. 6,037,021 to Yue Sin George Koo describes an artificial foliage article for Christmas trees. This foliage article comprises one or more branch stems in the form of plastics covered metal wires and a plurality of foliage bearing sub branches connected to the branch stem or stems. Each sub branch has an associated connector which defines an aperture therein to allow the sub branches to be push fitted onto the branch stem.

U.S. Pat. No. 4,161,768 to Ray J. Gauthier and Fred G. Caverzan describes an electrically lit artificial Christmas tree which is assembled from separate components consisting of a central stalk, a base which supports said stalk, and main branches which have secondary branches attached to them. The branches, comprising two stiff intertwined and insulated electrical wires, are attached to the central stalk by inserting their ends into holes provided in the stalk. This insertion connects the branches electrically to electrical conductors provided within the stalk which are then powered by an electric cord leading from the conductors in the stalk to an electrical wall outlet. The branches have Christmas tree decorative electric globes attached to them and are trimmed with artificial pine needles.

U.S. Pat. No. 3,167,467 to Abraham Abramson describes ornamental and decorative artificially simulated Christmas tree constructions to improve branch structure for such Christmas trees. Artificially simulated evergreen branch units of the character described are used primarily in combination with trunk elements of a knock down Christmas tree assembly. These evergreen branch units provide a simplified construction of a few and easily assembled parts, which parts are economical to manufacture especially of molded resinous plastic in quantity production and readily assembled into a variety of sizes and configurations with a minimum amount of unskilled labor. The branch units are colorful and attractive in appearance, relatively light in weight, yet rugged to withstand breakage in periodic assembly and dismantling. The branch units have electrical insulating properties for safety in mounting thereon electric wiring of decorative lighting outfits, and which shall be efficient and practical to a high degree in use.

None of these prior art references describe the present invention.

### SUMMARY OF THE INVENTION

It is an object of the present invention to provide a set of artificial tree limbs produced to aesthetically enhance an existing artificial or real tree by filling in sparse gaps or infusing more color, texture and decoration.

### BRIEF DESCRIPTION OF THE DRAWINGS

FIG. 1 is an illustrative close up, top down diagonal view of a tree branch extension resembling a fir tree branch, in accordance with the present invention showing the present invention with an attached pole clip for clipping it to the trunk of a tree or central pole of an artificial tree.

FIG. 2 is an illustrative close up, top down diagonal view of a tree branch extension incorporating stars.

FIG. 3 is an illustrative close up, top down diagonal view of a tree branch extension incorporating butterflies.

FIG. 4 is an illustrative close up, top down diagonal view of a tree branch extension incorporating holly leaves and berries.

FIG. 5 is an illustrative close up, top down diagonal view of a tree branch extension incorporating gems.

FIG. 6 is an illustrative close up, top down diagonal view of a tree branch extension incorporating snowflakes.

FIG. 7 is an illustrative close up, top down diagonal view of a tree branch extension resembling a fern frond or other very fine composite leaf foliage.

### DETAILED DESCRIPTION OF THE INVENTION

The present invention, hereinafter referred to as Decorative Tree Branch Extensions, is a set of artificial tree limbs or branches utilized to enhance the aesthetics of any artificial or real tree by filling in sparse gaps or infusing more color and texture. Decorative Tree Branch Extensions beautify an existing real or artificial tree simply by interspersing more branches throughout it. Decorative Tree Branch extensions are composed of any suitable material including, for example, recycled PVC plastic which is the same material used for branches in most artificial trees.

Decorative Tree Branch Extensions are fabricated in an assortment of branch variations including evergreen trees such as pine, balsam, fir or spruce, for example. Additionally, the branches can include star-shaped decorations, butterflies, flowers, snowflakes, gem shapes. Several different colors of pigment are available to mimic the structure, texture and color of natural needles, leaves, flowers, and insects. Additionally, the tree branch can have snow flake shapes, star shapes, gem shapes, or other geometrical shapes. Different colors to create lifelike artificial evergreen, balsam or pine foliage can be used. Branches also are manufactured in bright colors to add bursts of color throughout the tree.

Each branch extension 10 comprises an elongate decorative tree branch extension having a distal end and a proximal end comprising an elongate stem 16 which supports decorations 22 along at least fifty percent of the length of the stem 16 terminating at the distal end, and a flexible circular ring 14 at its proximal end, wherein the flexible circular ring 14 has an open section of arc 18 to receive the center pole or trunk of a tree.

A user simply pushes the open section of arc against the trunk or pole of a tree and snaps it onto an existing tree's pole or trunk. The flexible ring describes an arc of circle of approximately 220 to 270 degrees of arc.

The flexible ring can be comprised of plastic, flexible aluminum, or other suitable flexible material.

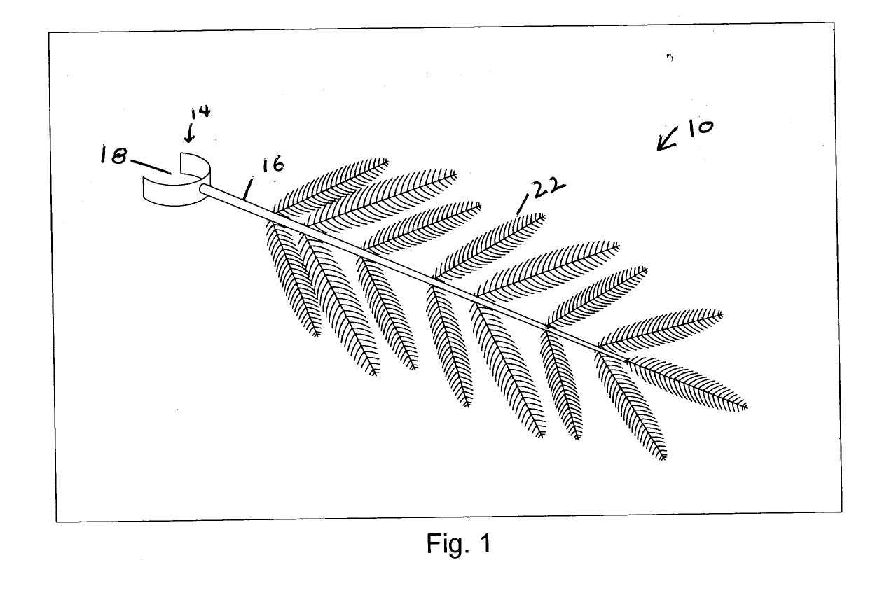

The stem 16 of the decorative tree branch extension comprises wire, plastic or other flexible material suitable for supporting the decorations 22. In FIG. 1, the decorations 22 comprise evergreen branches.

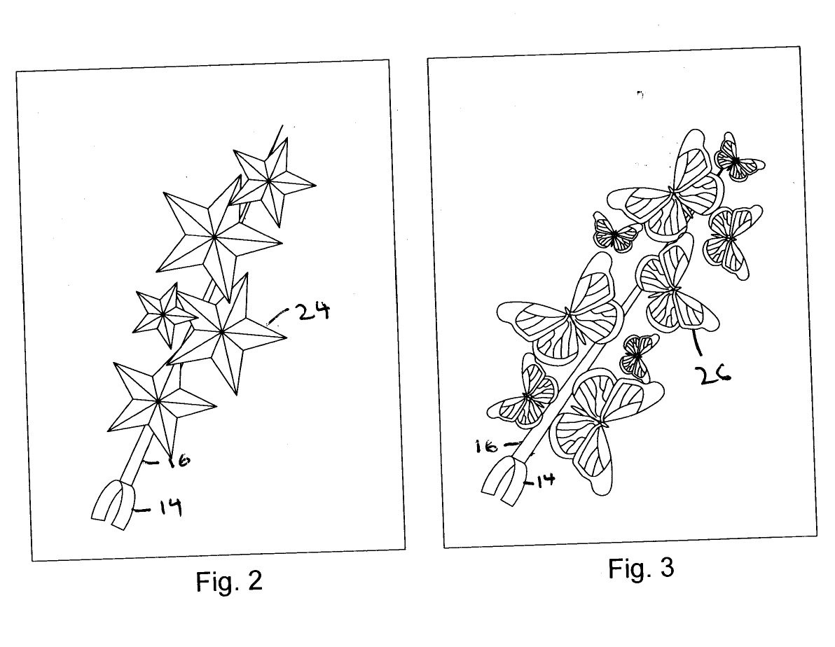

In FIG. 2, the decorations 24, are various sized star-shaped decorations.

In FIG. 3, the decorations 26, are various sized butterfly decorations.

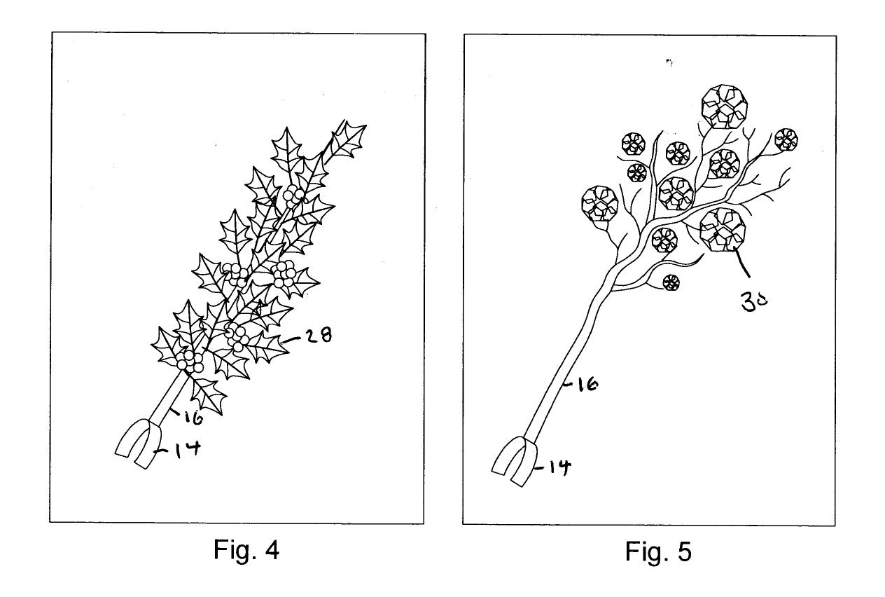

In FIG. 4, the decorations 28, are holly leaves and berries. In FIG. 5, the decorations 30, are various sized gem-shaped decorations.

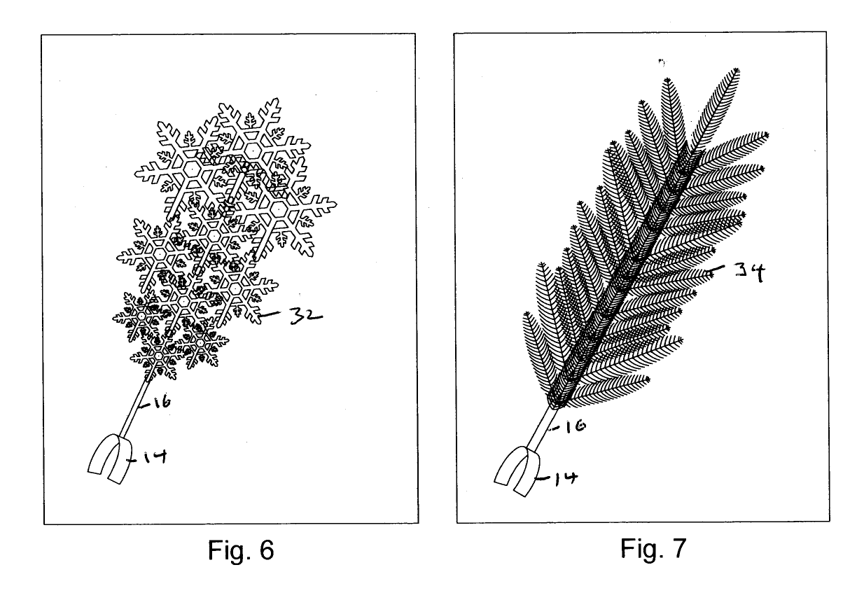

In FIG. 6, the decorations 32, are various sized snowflake-shaped decorations.

In FIG. 7, the decorations 34, resemble a fern frond or other very fine composite leaf foliage.

In the case of use for an artificial Christmas tree, the user simply assembles an artificial Christmas tree as usual. The user fluffs up the branches to create its fullest symmetry and then inserts the branch extensions of the present invention to fill in gaps where the tree seems to be sparse. Naturally colored lifelike extensions are inserted for consistent anonymity or brightly hued branches are inserted for interspersed bursts of color. Whether creating colorful themes or filling in a tree with gaps, Decorative Tree Branch Extensions make a holiday decorating process artistically satisfying. Using the tree branch extensions enhances and revives the appearance of an existing artificial or real tree in a practical and economical manner by eliminating the need to spend much more money on purchasing a new artificial tree. Durably constructed of quality environmentally sound materials, Decorative Tree Branch Extensions will withstand years of repeated use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An elongate decorative tree branch extension having a distal end and a proximal end comprising: an elongate stem which supports decorations along at least fifty percent of the length of the stem terminating at the distal end, and a flexible circular ring at its proximal end, wherein the flexible circular ring has an open section of arc to receive the stem or trunk of a tree.

2. The elongate decorative tree branch extension of claim 1, wherein the open section of arc is approximately from 220 to 270 degrees of arc.

3. The elongate decorative tree branch extension of claim 2, wherein the flexible ring can be comprised of plastic, flexible aluminum, or other suitable flexible material.

4. The elongate decorative tree branch extension of claim 2, wherein the stem of the decorative tree branch extension comprises wire, plastic or other flexible material suitable for supporting the decorations.

5. The elongate decorative tree branch extension of claim 2, wherein the decorations comprise evergreen branches.

6. The elongate decorative tree branch extension of claim 2, wherein the decorations comprise various sized star-shaped decorations.

7. The elongate decorative tree branch extension of claim 2, wherein the decorations comprise various sized butterfly decorations.

8. The elongate decorative tree branch extension of claim 2, wherein the decorations comprise holly leaves and berries.

9. The elongate decorative tree branch extension of claim 2, wherein the decorations comprise various sized gem shapes.

10. The elongate decorative tree branch extension of claim 2, wherein the decorations comprise various sized snowflake-shapes.

11. The elongate decorative tree branch extension of claim 2, wherein the decorations comprise a shape resembling a fern frond or other very fine composite leaf foliage.
